(19) United States
(12) Patent Application Publication
(10) Pub. No.: US 2020/0240769 A1
(43) Pub. Date: Jul. 30, 2020

(54) DEPTH AND SPECTRAL MEASUREMENT WITH WAVELENGTH-ENCODED LIGHT PATTERN

(71) Applicant: Cam4D Ltd., Tel Aviv (IL)

(72) Inventors: Yoav ZUTA, Tel Aviv (IL); Elad HAVIV, Tzurit (IL)

(73) Assignee: Cam4D Ltd., Tel Aviv (IL)

(21) Appl. No.: 16/257,564

(22) Filed: Jan. 25, 2019

(51) Int. Cl. G01B 11/22; G01N 21/31

(52) U.S. Cl. CPC G01B 11/22; G01N 21/31

(57) ABSTRACT

A depth or spectral measurement system includes an emission unit that is configured to emit light in a continuous wavelength-encoded light pattern in a continuous wavelength-encoded light pattern in which the emitted light varies with a direction of emission and in which the wavelength of the light that is emitted in each direction of emission is known. A camera is located at a known position relative to the emission unit and is configured to acquire an image of light that is returned by a scene that is illuminated by the wavelength-encoded light pattern. A sensor array of the camera onto which the scene is imaged is configured to enable analysis of the image by a processor of the system to determine a wavelength of light that is returned to the camera by a part of the scene and to calculate a depth of the part of the scene based on the determined wavelength.

### FIELD OF THE INVENTION

The present invention relates to depth and spectral measurement. More particularly, the present invention relates to a depth and spectral measurement using a wavelength-encoded light pattern.

### BACKGROUND OF THE INVENTION

Various technologies have been used to acquire three-dimensional information regarding an imaged scene. Such information may be useful in analyzing acquired images. For example, depth information may be utilized to determine exact locations of imaged objects, or to determine actual (and not apparent) sizes or relative sizes of imaged objects.

Previously described techniques for acquiring depth information may include techniques that are based on triangulation or on time-of-flight measurements. For example, stereo imaging in which images are acquired either concurrently or sequentially from different positions may enable extraction of depth information by triangulation. An imaging camera may be used together with a nearby time-of-flight depth sensor to provide distance information that may be registered with an acquired image. Such time-of-flight techniques may emit pulsed or modulated signals, e.g., of light emitted by a laser or light-emitting diode, ultrasound, or other pulse, and measure the time until a reflected signal is received.

Various techniques for hyperspectral imaging have been described. For example, a device that acquires images of a limited region (typically a line) may include optics (e.g., grating or prism) that disperses collected light over a two-dimensional sensor (e.g., in a direction that is orthogonal to the line). The device may then be scanned over a scene such that a spectral image may be acquired of an entire scene. Another technique may involve acquiring two-dimensional monochromatic images of the scene as the wavelength of the image is changed, e.g., by sequentially changing a filter through which the scene is imaged.

### SUMMARY OF THE INVENTION

There is provided, in accordance with an embodiment of the present invention, a depth measurement system including: an emission unit that is configured to emit light in a continuous wavelength-encoded light pattern in which the emitted light varies with a direction of emission and in which the wavelength of the light that is emitted in each direction of emission is known; and a camera that is located at a known position relative to the emission unit and that is configured to acquire an image of light that is returned by a scene that is illuminated by the wavelength-encoded light pattern, a sensor array of the camera onto which the scene is imaged configured to enable analysis of the image by a processor of the system to determine a wavelength of light that is returned to the camera by a part of the scene and to calculate a depth of the part of the scene based on the determined wavelength.

Furthermore, in accordance with an embodiment of the present invention, the emission unit includes a narrow bandpass filter that exhibits a blue shift effect.

Furthermore, in accordance with an embodiment of the present invention, a central wavelength of a spectral band of light that the narrow bandpass filter is configured to transmit at a nominal angle of incidence is selected to be a wavelength at a long wavelength end of a transition spectral region within which a spectral sensitivity of one type of sensor of the sensor array monotonically increases with increasing wavelength, and a spectral sensitivity of another type of sensor of the sensor array monotonically decreases with increasing wavelength.

Furthermore, in accordance with an embodiment of the present invention, the nominal angle of incidence is perpendicular to a surface of the narrow bandpass filter.

Furthermore, in accordance with an embodiment of the present invention, the emission unit is at least partially enclosed in walls having reflecting interior surfaces.

Furthermore, in accordance with an embodiment of the present invention, a light source of the emission unit includes a light emitting diode.

Furthermore, in accordance with an embodiment of the present invention, the emission unit is configured to enhance the brightness of light that is illuminating a part of the scene.

Furthermore, in accordance with an embodiment of the present invention, the sensor array includes a color filter array.

Furthermore, in accordance with an embodiment of the present invention, the color filter array includes a Bayer filter.

Furthermore, in accordance with an embodiment of the present invention, the camera includes a camera of a smartphone.

Furthermore, in accordance with an embodiment of the present invention, the system is connectable to a connector of a computer or smartphone.

Furthermore, in accordance with an embodiment of the present invention, the system is configured to operate at a plurality of known orientations relative to the scene.

Furthermore, in accordance with an embodiment of the present invention, the images that are acquired by the camera during operation at the plurality of known orientations may be analyzed to give a spectral description of a surface of the scene.

Furthermore, in accordance with an embodiment of the present invention, the system includes a reference surface having known spectral characteristics.

There is further provided, in accordance with an embodiment of the present invention, a depth measurement method including: operating an emission unit of a depth measurement system to emit light in a continuous wavelength-encoded light pattern such that a wavelength of the light that is emitted by the emission unit varies with a direction of emission such that the wavelength of the light emitted in each direction is known; operating a camera of the depth measurement system to acquire a color image of a scene that is illuminated by the wavelength-encoded light pattern; analyzing the color image by a processor to determine a wavelength of the light that was received from a part of the scene that is imaged onto an image pixel of a sensor array of the camera; and calculating by the processor a depth of the part of the scene based on the determined wavelength.

Furthermore, in accordance with an embodiment of the present invention, the emission unit includes a narrow bandpass filter exhibiting a blue shift.

Furthermore, in accordance with an embodiment of the present invention, calculating the depth includes applying a predetermined relationship between the determined wavelength and the depth of the part of the scene.

Furthermore, in accordance with an embodiment of the present invention, analyzing the color image to determine the wavelength includes calculating the wavelength based on signals from at least two types of pixels of the image pixel.

There is further provided, in accordance with an embodiment of the present invention, a method for acquiring a spectral description of a scene, the method including: operating an emission unit of the spectral imaging system to emit light in a continuous wavelength-encoded light pattern such that a wavelength of the light that is emitted by the emission unit varies with a direction of emission such that the wavelength of the light emitted in each direction is known; operating a camera of the depth measurement system to acquire an image of a scene that is illuminated by the wavelength-encoded light pattern; processing the acquired image to calculate a wavelength and an intensity of light that is returned by each part of the scene; and when the acquired images of a part of the scene do not include measurements at all wavelengths of a predetermined set of wavelengths, rotating the spectral imaging system so that that part of the scene is illuminated by another wavelength of the wavelength-encoded light pattern.

Furthermore, in accordance with an embodiment of the present invention, processing the acquired images comprises utilizing results of a depth measurement in calculating the wavelength or in calculating the intensity.

### BRIEF DESCRIPTION OF THE DRAWINGS

In order for the present invention, to be better understood and for its practical applications to be appreciated, the following Figures are provided and referenced hereafter. It should be noted that the Figures are given as examples only and in no way limit the scope of the invention. Like components are denoted by like reference numerals.

FIG. 1 schematically illustrates a depth measurement system in accordance with an embodiment of the present invention.

FIG. 2 schematically illustrates an emission unit of the depth measurement system shown in FIG. 1.

FIG. 3A schematically illustrates a pattern of light emitted from the emission unit shown in FIG. 2.

FIG. 3B schematically illustrates an effect of distance on an element of the pattern shown in FIG. 3A.

FIG. 4 schematically illustrates a sensor of a color camera of the depth measurement system shown in FIG. 1.

FIG. 5 schematically illustrates selection of a wavelength range of the pattern shown in FIG. 3A.

FIG. 6A schematically illustrates an emission unit that is configured to enhance illumination of a region of a scene.

FIG. 6B schematically illustrates a wavelength-encoded light pattern that is emitted by the emission unit shown in FIG. 6A.

FIG. 7 schematically illustrates use of the depth measurement system shown in FIG. 1 for hyperspectral imaging.

FIG. 8A schematically illustrates a smartphone that is provided with a depth measurement system as shown in FIG. 1.

FIG. 8B schematically illustrates a smartphone that is provided with a plugin depth measurement system as shown in FIG. 1.

FIG. 9 is a flowchart depicting a method of operation of a depth measurement system, in accordance with an embodiment of the present invention.

FIG. 10 is a flowchart depicting a method for acquiring a spectral description of a scene using the system shown in FIG. 1.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, the conjunction “or” as used herein is to be understood as inclusive (any or all of the stated options).

Some embodiments of the invention may include an article such as a computer or processor readable medium, or a computer or processor non-transitory storage medium, such as for example a memory, a disk drive, or a USB flash memory, encoding, including or storing instructions, e.g., computer-executable instructions, which when executed by a processor or controller, carry out methods disclosed herein.

In accordance with an embodiment of the present invention, a depth measurement system includes an emission unit. The emission unit is configured to emit light that spectrally encodes an angle of emission such that the wavelength of light that is emitted in each direction is known. When the emission unit is used to illuminate a scene that includes various objects or surfaces, each part of the scene may be illuminated by light in a narrow spectral band that depends on an angle between that part of the scene and a reference direction (e.g., a normal to a front surface of the emission unit). A function that relates wavelength of the emitted light to an angle of emission is referred to herein as a spectral encoding function. For example, a typical emission unit includes a light source (e.g., light emitting diode or other light source) and a dispersing element, typically a thin film optical filter such a a narrow bandpass filter).

An image of a scene that is illuminated by the spectrally encoded light that is emitted by emission unit, and that reflects or scatters incident light, may be acquired by a color camera. A scene may include various elements such as topographical features, manmade structures, plants, objects, people, vehicles, animals, or other components of an imaged scene. The color of each part of the scene in the acquired color image may be determined by the wavelength of the emitted light that was incident on that part of the scene. Thus, analysis of the acquired images may utilize knowledge of the spectrum of the emitted pattern and of characteristics of the emission unit and color camera to yield a measurement of distance to each imaged object in the image. Alternatively or in addition, images that are acquired the system as the system is scanned (e.g., panned, tilted, or translated) across a scene may be processed to yield hyperspectral data of the scene.

For example, the emission unit may include a light source and a dispersion element. The light source may include a wideband light emitting diode (LED). The spectral range of the light that is emitted by a wideband light source is sufficiently wide so as to include at least the entire spectral range of the resulting wavelength-encoded light pattern. As used herein, the terms “light”, “light source”, and similar terms refer to visible or infrared light or to other light that may be diffracted, refracted, or dispersed by an optical element.

A dispersion element may include a flat multilayered dielectric that is configured to function at a narrow bandpass filter. The narrow bandpass filter is typically configured to transmit light in a narrow spectral band (e.g., having a width of no more than 10 nm) about a central design wavelength λ₀ when the light is incident on the filter at a nominal angle of incidence. Since the narrow bandpass filter typically consists of an arrangement of flat dielectric layers with parallel and planar sides, light is transmitted by the narrow bandpass filter in a direction that is parallel to the direction of incidence. For example, the nominal angle of incidence may be 0° to the normal to the filter, e.g., perpendicular to the surface of the filter.

When light is incident on the filter at an angle θ that deviates from the nominal angle of incidence, the central wavelength λ of the transmitted band is shifted toward a shorter wavelength than λ₀, referred to as exhibiting a blue shift angular effect. Thus, when the nominal angle of incidence is 0°, a central transmitted beam centered on λ₀ may be surrounded by rings of light of increasing angle from 0° and increasingly shorter wavelength. For example, when the nominal angle of incidence is 0°, the central wavelength λ of a ring of transmitted light emerging from the filter at angle θ to the normal (or blue shift effect) may be approximated by the blue shift formula:

$$λ ( θ ) = {λ}_{0} \sqrt{1 - {( \frac{sin θ}{{n}_{eff}} )}^{2}} ,$$

where n_{eff} represents an effective index of refraction of the filter (based on the indices of refraction of the individual layers of the filter). This approximate formula may describe at least the general form of the spectral encoding function of the emission unit. The wavelength of the emitted light may thus vary as a continuous and monotonic function of angle of emergence. It may also be noted that techniques known in the art for filter construction (e.g., thicknesses and indices of refraction of each layer) may control the exact form of the blue shift (e.g., in effect, an angular dependence of the effective index of refraction). It may be noted that a more exact calculation of the blue shift may entail a calculation that includes the properties of each layer of the filter (e.g., thickness, index of refraction as function of wavelength, and angle of incidence).

Other types of dispersing optical elements may be used, possibly characterized by different angular dependence of emitted wavelength.

The color camera typically includes imaging optics that focus light that is reflected or scattered by the scene onto a sensor in the form of an array of light sensitive pixels. Different pixels in each region of the sensor array are sensitive to different spectral regions, such that light from each region of the scene (in accordance with a spatial resolution of the camera) is sensed by different sensors with different spectral sensitivities. Each pixel may be configured to generate an electronic signal that is indicative of the light that is sensed by that pixel. Knowledge of the wavelength sensitivity of each pixel may enable analysis of the sensor signals to determine the wavelength of light that is reflected by each part of the scene.

For example, a sensor array of identical sensors may be covered by a color filter array (e.g., a Bayer filter, or other arrangement of filters that transmit different spectral ranges). The color filter array includes an array of filters, each filter covering a single pixel of the sensor. Each filter is characterized by a spectral transmission function that specifies transmission as a function of wavelength. In a typical color filter array, there are three or four different types of filter elements, each type characterized by a different spectral transmission. For example, an RGB color filter array includes three types of filters, each transmitting primarily in either the red, green, or blue ranges of the visible spectrum. An RGB-IR filter may include a fourth type of filter that transmits primarily in the near infrared (NIR) spectral range. Other types and arrangements of filters of a color filter array have been described, or may be used. The filters are arranged such that each region of the sensor array, herein referred to as an image pixel, onto which is imaged a different element of the scene (in accordance with the spatial resolution of the camera) includes at least one of each type of filter element.

The signals from pixels of the sensor array may be analyzed, utilizing the spectral transmission function of each filter of the color filter array, to determine a wavelength of the light that is incident on each image pixel. For example, one or more numerical or analytic techniques known in the art may be applied to the sensor measurements and an array of functions that relate wavelength to pixel signal (e.g., the spectral transmission functions, products of the spectral transmission functions and the spectral sensitivity of the sensor, or other similar functions) to solve for the wavelength of the light that is incident on each image pixel.

Similarly, the position of each image pixel on the sensor array may be analyzed, utilizing characteristics of the optics of the camera (e.g., focal length of lens, focal distance between lens and sensor, orientation of optical axis of the camera, or other characteristics of the optics of the camera) and applying known principles of geometrical optics, to determine an angle of incidence of an incident ray of light relative to an optical axis of the camera.

Analysis, applying various known geometric and trigonometric techniques to the data regarding wavelength and angle of incidence of a ray, and utilizing the spectral encoding function of the emission unit, may yield a distance of an element of the scene that reflected or scattered that ray toward the camera. For example, the angular incidence of each wavelength may be known for a reference surface. The reference surface may include, e.g., a flat surface that is normal to an optical axis of the depth measurement system, a surface in the form of a concave spherical section centered at the depth measurement system, or another reference surface at a reference distance from the depth measurement system. For example, the angular incidence may be calculated using known angular relationships of the depth measurement system, or may be determined during calibration measurements using such a surface (e.g., having a scattering surface).

An angle of incidence of a ray of a particular wavelength and that is reflected or scattered by an element of scene may be measured. The measured angle of incidence may be compared with a reference angle of incidence of a ray of that wavelength from the reference surface. A deviation of the measured angle of incidence for a ray of a particular wavelength from the reference angle of incidence for that wavelength may be converted to a distance of the element of the scene relative to the reference surface. For example, a relationship between measured angle of incidence and distance for each wavelength may be calculated based on distances and angles that are known for the reference surface. This relationship may be converted to a relationship that converts a wavelength measured at each image pixel to a distance to a scene element at the angle from the camera axis that corresponds to that image pixel. This relationship may be expressed in the form of a function (e.g., approximated by a polynomial or other parameterized formula), as a lookup table, or otherwise.

In some cases, a wavelength band of the emitted light may be selected so as to optimize sensitivity of the depth measurement system. For example, a spectral sensitivity of a type pixel may be visualized as a graph of sensitivity (e.g., expressed as quantum efficiency) versus wavelength. Typically, the graph is in the form of a peak. The spectral sensitivities of pairs of two types of pixels that are sensitive to neighboring spectral ranges (e.g., blue and green, green and red, red and infrared, other pairs of pixel types) typically overlap in spectral ranges in which the spectral sensitivities of the pair have similar values. Selection of a narrow bandpass filter whose central peak falls within such overlap ranges (e.g., near the long wavelength end of the range) may provide more accurate calculation of wavelength than in a range where the sensitivity of one type of pixel is one or more orders of magnitude greater than that of the other types of pixels.

In some cases, the light source of the emission unit may be enclosed within an enclosure with scattering or with (curved or tilted) specular interior walls, with the narrow bandpass filter forming one of the walls. The reflecting walls may reorient ray of a particular wavelength that was reflected backward by the narrow bandpass filter to be incident on the filter at an angle of incidence that would permit that ray to be transmitted. Thus, light that is emitted by the light source may be more effectively utilized.

When the depth measurement system is operated in the presence of ambient lighting, one or more operations may be performed to distinguish light that is emitted by the emission unit and reflected by the scene from ambient light that is reflected by the scene. For example, a reference image of the scene may be acquired by the color camera prior to operation of the emission unit (or after operation of the emission unit). A depth measurement image of the scene when the scene is illuminated by spectrally encoded light that is emitted by the emission unit may be acquired. The reference image may then be subtracted from the depth measurement unit to correct for coloring by the ambient light. The corrected image may then be analyzed to yield distance measurements to elements of the scene. In the event that the ambient lighting is variable (e.g., fluorescent lighting, variable cloudiness, or other variable ambient lighting), a reference image may include averaging of a sufficient number of exposures to eliminate the effects of the variation, or acquiring the reference image as a single exposure that is long enough to eliminate the effects.

The emission unit may be optimized so as to preferentially illuminate a particular direction or region of a scene. For example, such optimization may include providing capability to facilitate aiming the emitted light, e.g., a tiltable or moveable light source within the emission unit, or an additional reflective (e.g., mirror) or refractive (e.g., prism or lens) element to enable aiming of the emitted light. Various properties of the emission unit may be selected as suitable for a particular application. Such properties may include the size of the narrow bandpass filter, layer structure of the narrow bandpass filter (e.g., determining a central wavelength and blue shift function), selection of a light source with a particular emission spectrum, or other properties.

A depth measurement system may be advantageous over other systems and techniques for depth measurement. For example, an emission unit may be made sufficiently small (e.g., in one example, 2.5 mm×2.5 mm×1.5 mm) to enable attachment to many existing imaging devices, such near the camera of a smartphone or portable computer, on an endoscope or catheter, or on another portable device that includes a camera. A small and low power emission unit may not require any cooling or thermal dissipation structure. The continuous spectral pattern that is emitted by the emission unit may enable more precise depth measurement and greater stability than use of an emitted pattern where the wavelength changes in discrete steps. Measurements by the system are dependent only on relative signals by pixels of different spectral sensitivity to a single wavelength within an image pixel. Therefore, the system may be insensitive to fluctuations in brightness and spectrum of the source. A dispersion element in the form of a narrow bandpass filter, as opposed to other types of dispersion elements (e.g., a prism or grating) typically spread the wavelengths over an angular range that may be too small to cover a scene. Use of a small source together with narrow bandpass filter typically does not require collimation or lenses. Therefore, tolerances for relative placement of components may be much less stringent for other types of dispersing elements.

In some cases, relative rotation between the depth measurement system and an object being imaged may enable hyperspectral imaging of the object. The wavelength of the illumination that impinges on each part of the object may be known. In some cases, the measured depth information may be utilized to adjust for the dependence of intensity on distance. Rotation of the depth measurement system in a known manner, e.g., panning, tilting, or both, will successively illuminate each part of the object with different wavelengths of light. Known tracking or image registration techniques (e.g., based on correlations between successively acquired images, or otherwise) may be applied to enable determination of the intensity as a function of wavelength of the light that is returned (e.g., reflected or scattered) toward the camera. If the spectral intensity of the emitted light is known (e.g., by using a reference sensor or monitoring a reference surface of known spectral reflectivity), the spectral reflectance or scattering properties of each region of the surface of the object may be known. In some cases, multiple emission units may be utilized to cover different spectral ranges. It may be noted that if the angular dependence of wavelength of the emitted light is known, and if the object is at a known position relative to the depth measurement system (e.g., as a result of a previous depth measurement, or otherwise, e.g., being placed or supported at a known fixed position relative to the depth measurement system) it may not be necessary to utilize color imaging capability to measure the wavelength of the light. Thus, an imaging device with a monochromatic (and possibly more sensitive) sensor may be used.

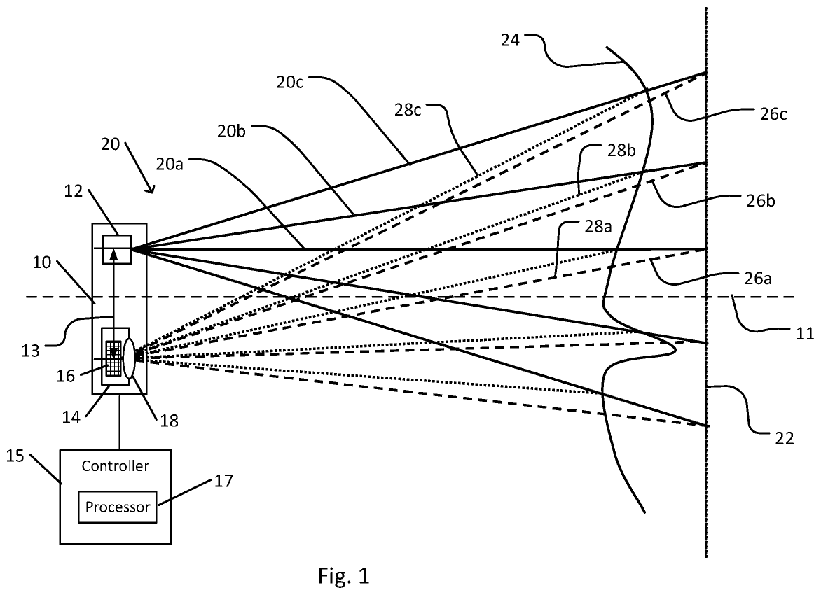

FIG. 1 schematically illustrates a depth measurement system in accordance with an embodiment of the present invention.

Depth measurement system 10 includes an emission unit 12 and a color camera 14 that is positioned at a known displacement and orientation relative to emission unit 12. For example, emission unit 12 and color camera 14 may be separated by baseline distance 13. Typically, emission unit 12 and color camera 14 are fixed to a single rigid base or housing. Thus, baseline distance 13 may be fixed and known. In some cases, on or both of emission unit 12 and color camera 14 may be moveable, e.g., to fixed locations relative to one another, such that baseline distance 13 may be adjustable but known.

Emission unit 12 is configured to illuminate scene surface 24 (schematically representing reflecting or scattering surfaces of a scene) with wavelength-encoded light pattern 20. In wavelength-encoded light pattern 20, each ray that is emitted at a different angle to system axis 11 (e.g., each ray in a bundle of rays in the form of a conical shell whose apex angle is equal to twice the angle of the ray with system axis 11), such as each of emitted rays 20a, 20b, and 20c, is characterized by a known different wavelength. In a typical depth measurement system 10, emission unit 12 is configured such that the wavelength of the emitted light decreases as a monotonic function of increasing angle of emission with respect to system axis 11. Thus, in the example shown, the wavelength of emitted ray 20c is shorter than the wavelength of emitted ray 20b which is shorter than the wavelength of emitted ray 20a.

Color camera 14 includes camera sensor 16. Camera sensor 16 typically includes a plurality of pixels that are each sensitive to a particular spectral range. Typically, pixels of camera sensor 16 are arranged in repeating groups of adjacent pixels arranged such that such that each group of adjacent pixels includes at least one pixel that is sensitive to each of the spectral ranges. Each such group is referred to herein as an image pixel. Alternatively, color camera 14 may include a plurality of mutually aligned cameras (e.g., each with separate optics and sensors) that are each sensitive to a different wavelength range. Other arrangements of color cameras may be used.

Camera optics 18 are configured (within the limitations of any aberrations of camera optics 18) to focus all light rays that impinge on a front surface or entrance aperture of camera optics 18 to be focused at a single point on camera sensor 16. In particular, the light that is focused on a single image pixel of camera sensor 16 consists of rays that are incident on camera optics 18 from a single direction with respect to an optical axis of camera optics 18 (e.g., within limitations of the spatial resolution and optical aberrations of color camera 14 and camera optics 18).

A calibration of depth measurement system 10, either by analysis of actual measurements or by applying raytracing analysis, may yield an expected wavelength of light that is detected by each image pixel of color camera 14 when measuring a reference surface 22. For example, reference surface 22 may represent a flat surface that is orthogonal to system axis 11 at a known distance from depth measurement system 10, a surface in the form of a spherical sector of known radius that is centered on depth measurement system 10 (e.g., centered on emission unit 12, color camera 14, or a point between emission unit 12 and color camera 14), or another surface of known shape and position. Reference surface 22 may be assumed to be a textured or scattering surface that is configured to reflect or scatter each ray of known wavelength of wavelength-encoded light pattern 20, e.g., emitted ray 20a, 20b, or 20c in the example shown, toward color camera 14, e.g., as reference ray 26a, 26b, or 26c, respectively. Focusing by camera optics 18 focusses each reference ray 26a, 26b, or 26c to a particular image pixel of camera sensor 16.

When depth measurement system 10 is used to measure a depth to scene surface 24, an emitted ray 20a-20c is reflected or scattered toward color camera 14 by scene surface 24 as scene ray 28a, 28b, or 28c, respectively, in the example shown. When the distance between depth measurement system 10 and scene surface 24 is measurably different from the distance to reference surface 22, the angle of incidence on camera optics 18 of each scene ray 28a, 28b, or 28c is different from that of the corresponding references.

Therefore, for example, an image of scene ray 28a, having the same wavelength as reference ray 26a, will be formed at a different pixel than would the image of reference ray 26a. Utilizing known distances (e.g., from depth measurement system 10 to reference surface 22, baseline distance 13, or other distances) and measured or known angles (e.g., of emitted ray 20a, reference ray 26a, and scene ray 28a), as well as standard trigonometric relations for oblique triangles (e.g., law of sines, law of cosines, or other relationships), a distance from emission unit 12 or from color camera 14 to a point of intersection of emitted ray 20a or of scene ray 28a with scene surface 24 may be calculated. Equivalently, a relationship of the wavelength of light sensed by each image pixel of camera sensor 16 (each image pixel corresponding to a particular angle of incidence of a scene ray on camera optics 18) and a distance to scene surface 24 along that scene ray may be calculated. For example, the relationship may be expressed or approximated as a functional relationship (e.g., approximated by a polynomial function) or as a lookup table.

Controller 15 may control operation of depth measurement system 10, and includes at least a processor 17 for analyzing images that are acquired by color camera 14. For example, processor 17 may be incorporated into depth measurement system 10, or may include a processor of a stationary or portable computer, smartphone, or other device (e.g., functioning as a host device) that may communicate via a wired or wireless connection with depth measurement system 10.

A typical emission unit 12 may include a light source and a narrow bandpass filter.

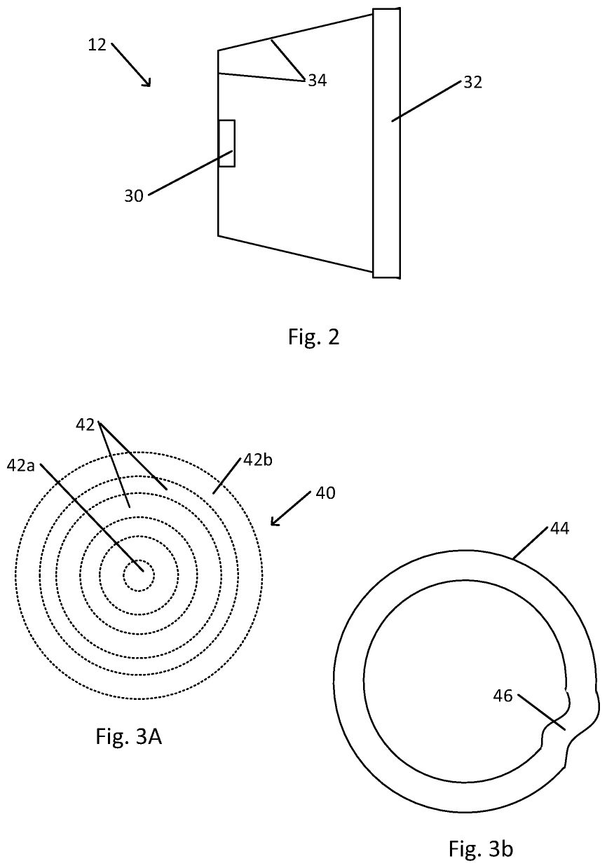

FIG. 2 schematically illustrates an emission unit of the depth measurement system shown in FIG. 1.

Emission unit 12 includes a light source 30. Light source 30 may emit light omnidirectionally or in a preferred direction. Light source 30 is configured to emit light in a spectral range that is sufficiently broad to enable formation of wavelength-encoded light pattern 20 by dispersion of the emitted light by a dispersive transmissive element, such as narrow bandpass filter 32 in the example shown.

In the example shown, light source 30 of emission unit 12 is enclosed in an opaque enclosure with reflective walls 34. For example, reflective walls 34 may be specular or scattering. Light that is emitted by light source 30 may exit the enclosure only via a narrow bandpass filter 32. Narrow bandpass filter 32 is transmissive to light that is incident on narrow bandpass filter 32 within an angular range that depends on the effective index of refraction n_{eff} of narrow bandpass filter 32 (e.g., as indicated by the blue shift formula that is presented above). Light that is emitted by light source 30 and that is incident on narrow bandpass filter 32 at an angle that is not transmissible may be reflected backward toward reflective walls 34. Reflection by reflective walls 34 may redirect the light (e.g., by a tilt of reflective walls 34 as in the example shown, or by scattering from reflective walls 34) so as to redirect the light toward narrow bandpass filter 32 at a different angle of incidence that may be transmissible. Such reflections may continue until the light emerges via narrow bandpass filter 32 (or until its energy is absorbed and converted to heat within emission unit 12). Alternatively or in addition, light source 30 may be attached (e.g., bonded or attached using suitable bonding agents or attachment structure) directly to narrow bandpass filter 32. In this case, the redirection effect may be produced without any need for reflective walls.

FIG. 3A schematically illustrates a color encoded pattern of light emitted from the emission unit shown in FIG. 2.

In the example shown, wavelength-encoded light pattern 40 (which may be considered to be an alternative graphical representation of wavelength-encoded light pattern 20 as shown in FIG. 1) includes a circularly symmetric pattern of concentric annular regions 42. Each concentric angular region 42 represents light in a different wavelength band. In accordance with the blue shift formula, the wavelength decreases with increased angular deviation from system axis 11. Therefore, in wavelength-encoded light pattern 40 that emerges via narrow bandpass filter 32, the light in concentric angular region 42a may have a maximum transmitted wavelength, while the light in concentric angular region 42b may have a minimum wavelength. (It should be understood that the representation of wavelength-encoded light pattern 40 as distinct concentric rings is schematic only. A typical actual wavelength-encoded light pattern 40 would appear as a continuous pattern in which the color and wavelength gradually decreases in wavelength with radial distance from the center of wavelength-encoded light pattern 40.)

As described by the blue shift formula, light that emerges from emission unit 12 via narrow bandpass filter 32 approximately normal to narrow bandpass filter 32 (e.g., parallel to system axis 11) has a maximum wavelength. Light that emerges at oblique angles to system axis 11 has a shorter wavelength, as indicated approximately by the blue shift formula (or by more exact calculations as known in the art), up to a minimum wavelength, e.g., that is dependent on n_{eff}.

When wavelength-encoded light pattern 40 is reflected from reference surface 22, the form of the reflected light (e.g., as represented by reference rays 26a-26b) may preserve the form of wavelength-encoded light pattern 40 (e.g., except, in some cases, for possible elongation such that circular contours may become elliptical contours). However, when a distance to a part of scene surface 24 deviates from the distance to reference surface 22, the reflected pattern may be distorted (e.g., from a regular circularly symmetric or elliptically symmetric pattern).

FIG. 3B schematically illustrates an effect of distance on an element of the pattern shown in FIG. 3A.

Reflected pattern 44 represents a reflection of an annular region 42 of wavelength-encoded light pattern 40. In reflected pattern 44, a distance to region of scene surface 24 that reflected the light in section 46 of reflected pattern 44 was different from the distance to the regions of scene surface 24 that formed the remainder of reflected pattern 44. Equivalently, imaged light that is sensed by an image pixel onto which section 46 is imaged will have a different wavelength than light that would otherwise be imaged onto that pixel.

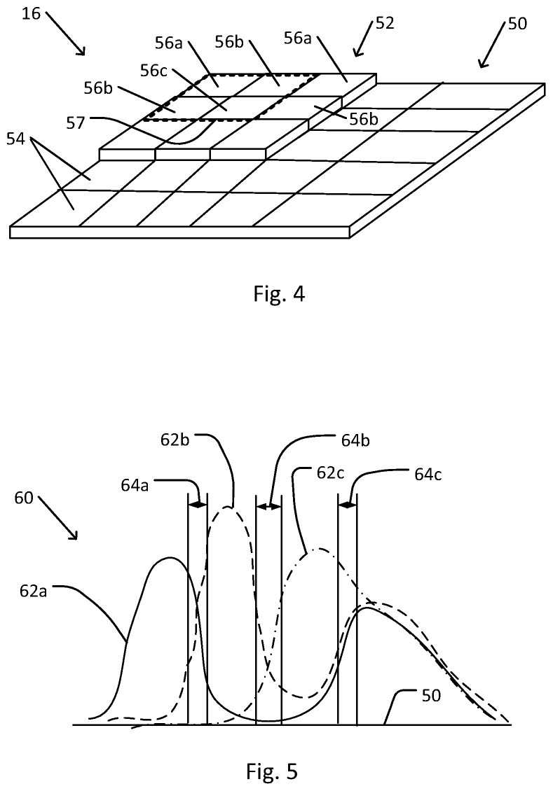

FIG. 4 schematically illustrates a sensor of a color camera of the depth measurement system shown in FIG. 1.

In camera sensor 16, sensor array 50 includes an array of sensors 54. For example, electronics that are connected to camera sensor 16 may individually measure light intensity that impinges on, and is sensed by, each sensor 54.

Sensor array 50 is covered by color filter array 52 (shown, for clarity, as covering only part of sensor array 50). Color filter array 52 includes an array of color selective filters. In the example shown, color filter array 52 includes three types of color selective filters 56a, 56b, and 56c. Other types of color filter arrays may include more (or, in some cases, fewer) types of color selective filters. For example, in a typical RGB Bayer filter, color selective filter 56a may be configured to transmit blue light (e.g., with a spectral transmission described by filter transmission curve 62a in FIG. 5), color selective filter 56b may be configured to transmit green light (e.g., with a spectral transmission described by filter transmission curve 62b), and color selective filter 56c may be configured to transmit red light (e.g., with a spectral transmission described by filter transmission curve 62c). Each combination of a sensor 54 and the color selective filter 56a, 56b, or 56c that covers that sensor 54 is referred to herein as a pixel of camera sensor 16.

A set of adjacent pixels (e.g., sensors 54 that are covered by a set of color selective filters 56a, 56b, and 56c) that form a repeating pattern in color filter array 52 (and that includes all of the types of color selective filters that are present in color filter array 52) may be considered to form an image pixel 57. (It may be noted that a partition of camera sensor 16 into image pixels 57 may be arbitrary, such that alternative partitions into image pixels 57 are possible, typically with minimal or imperceptible effect on measurement or calculation results.) Signals generated by each sensor 54 of image pixel 57 may be analyzed (e.g., by application of one or more techniques for solving systems of simultaneous equations) to yield a wavelength of light that impinged upon, and was detected by, image pixel 57.

As described above, a wavelength of light that is detected by a particular image pixel 57 may be interpreted to yield a distance to, or depth of, a part of scene surface 24 in a direction that corresponds to scene rays that originated from that part of scene surface 24.

Light source 30, narrow bandpass filter 32, or both may be selected so as to facilitate, or increase the accuracy of, a calculation of wavelength of light that impinged on an image pixel 57.

FIG. 5 schematically illustrates selection of a wavelength range of the pattern shown in FIG. 3A.

In spectral sensitivity graph 60, horizontal axis 50 represents wavelength and the vertical axis represents spectral sensitivity (e.g., expressed as quantum efficiency) of different pixels (e.g., sensors 54 covered with different color selective filters of color filter array 52) of an image pixel 57 of a camera sensor 16 of color camera 14. For example, spectral sensitivity curve 62a may represent the sensitivity of a pixel that includes a sensor 54 covered by a first type of color selective filter (e.g., color selective filter 56a, e.g., transmissive of blue light). Similarly, spectral sensitivity curve 62b may represent the sensitivity of a sensor 54 covered by a second type of color selective filter (e.g., color selective filter 56b, e.g., transmissive of green light). Spectral sensitivity curve 62c may represent the sensitivity of a sensor 54 covered by a third type of color selective filter (e.g., color selective filter 56c, e.g., transmissive of red light).

It may be noted that at least adjacent spectral sensitivity curves partially overlap one another. For example, spectral sensitivity curve 62a partially overlaps spectral sensitivity curve 62b, and spectral sensitivity curve 62b partially overlaps spectral sensitivity curve 62c. It may be further noted that in transition spectral region 64a, the spectral sensitivity values represented by spectral sensitivity curve 62a and spectral sensitivity curve 62b at each wavelength are similar to one another (e.g., at have spectral sensitivity values that are within less than a single order of magnitude of one another). It may be further noted that in transition spectral region 64a, the spectral sensitivity that is represented by spectral sensitivity curve 62a is monotonically and sharply (e.g., with maximally negative slope) decreasing with increased wavelength, while the spectral sensitivity that is represented by spectral sensitivity curve 62b is monotonically and sharply (e.g., with maximum positive slope) increasing. Similarly, in transition spectral region 64b, the spectral sensitivity values represented by spectral sensitivity curve 62b and spectral sensitivity curve 62c at each wavelength are similar to one another. In transition spectral region 64b, the spectral sensitivity that is represented by spectral sensitivity curve 62b is monotonically and sharply decreasing with increased wavelength, while the spectral sensitivity that is represented by spectral sensitivity curve 62c is monotonically and sharply increasing. In transition spectral region 64c, the spectral sensitivity values represented by spectral sensitivity curves 62a, 62b, and 62c at each wavelength are similar to one another. In transition spectral region 64c, the spectral sensitivities that are represented by spectral sensitivity curves 62a and 62b are monotonically increasing with increased wavelength, while the spectral sensitivity that is represented by spectral sensitivity curve 62c is monotonically decreasing. In other spectral regions, the spectral sensitivity represented by one spectral sensitivity curve is much larger than that represented by other spectral sensitivity curves, and one or more spectral sensitivity curves may be at an extremum where the curve is neither increasing nor decreasing monotonically.

Therefore, when a reflection of wavelength-encoded light pattern 40 that is imaged by color camera 14 lies within a transition spectral range, e.g., transition spectral region 64a or 64b, the wavelength of light that is imaged onto a particular image pixel 57 may be calculated (e.g., by solving a set of simultaneous equations) more accurately and less ambiguously than the wavelength of light in another spectral region where the spectral sensitivity of one type of pixel is much greater than that of other types, and where the sensitivity is relatively independent of wavelength.

Accordingly, emission unit 12 may be configured such that the spectrum of wavelength-encoded light pattern 40 lies entirely or mostly within a transition spectral range, e.g., transition spectral region 64a or 64b. For example, a structure of narrow bandpass filter 32 (e.g., compositions and thicknesses of layers of narrow bandpass filter 32), or a spectrum of light source 30, may be designed such that a central concentric angular region 42a of wavelength-encoded light pattern 40 has a wavelength at the long wavelength end of transition spectral region 64a or 64a, while an outermost concentric angular region 42b has a wavelength at a short wavelength end of transition spectral region 64a or 64b.

In some cases, an emission unit may be configured to preferably emit light in one or more specific directions, e.g., to provide enhanced or brighter illumination to a selected region of a scene.

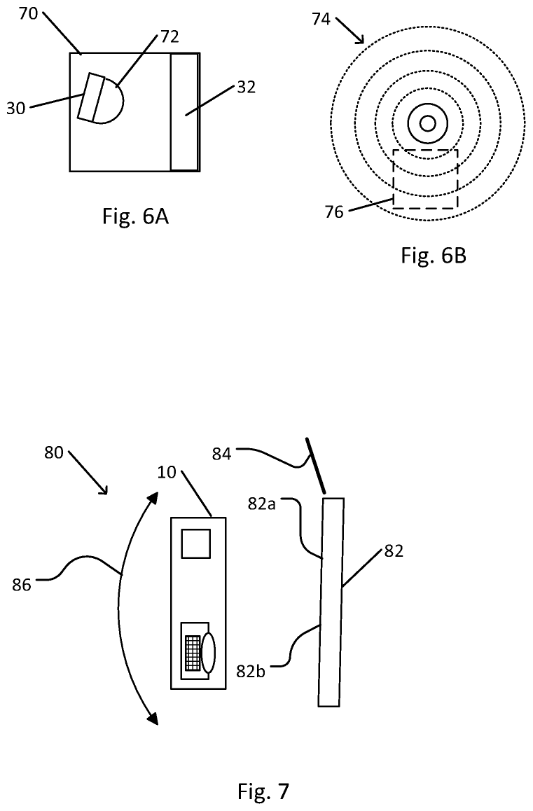

FIG. 6A schematically illustrates an emission unit that is configured to enhance illumination of a region of a scene. FIG. 6B schematically illustrates a wavelength-encoded light pattern that is emitted by the emission unit shown in FIG. 6A.

In the schematic example of emission unit 70 that is shown, light source 30, e.g., provided with source optics 72 (e.g., collimating or directing optical elements), may be rotated so as to enhance the brightness of region 76 of wavelength-encoded light pattern 74. In some cases, all of emission unit 70 may be rotatable, or other elements (e.g., narrow bandpass filter 32) of emission unit 70 may be individually rotatable. In some cases, a size, relative position, orientation, spectrum, or other characteristics of components of emission unit 70 (e.g., light source 30, source optics 72, narrow bandpass filter 32, or other components of emission unit 70) may be selected so as to provide a particular wavelength-encoded light pattern 40 with a selected spatial brightness distribution. In some cases, collimating, focusing, or aiming optics, such as reflecting or refracting elements, may be located outside of emission unit 70.

Source optics 72 may be internal to emission unit 70, as in the example shown, or external to emission unit 70. In some cases, external optics may distort the emitted pattern, e.g., so that wavelength-encoded light pattern 20 is not circularly symmetric when emitted. However, even when wavelength-encoded light pattern 20 is distorted, a relationship between wavelength and distance may be established via calculation or calibration measurements.

In some cases, one or more components of depth measurement system 10, e.g., emission unit 12, may be incorporated into other applications. For example, emission unit 12 may be incorporated into a stereo imaging system. For example, illumination of a scene with wavelength-encoded light pattern 20 may facilitate identification of corresponding regions in images acquired by two mutually spatially displaced cameras. Thus, the illumination with wavelength-encoded light pattern 20 may registration of the images using less computational power than may be required using conventional image processing techniques.

In some cases, depth measurement system 10 may be operated to enable spectral imaging (e.g., multispectral or hyperspectral imaging) of an object or scene.

FIG. 7 schematically illustrates use of the depth measurement system shown in FIG. 1 for spectral imaging.

In spectral imaging system 80, depth measurement system 10 is operated to acquire successive images of an object 82 (e.g., all or part of a scene surface 24). Between acquisitions of successive images, depth measurement system 10 may be rotated with a rotation 86. Rotation 86 may represent panning or tilting of depth measurement system 10, or both panning and tilting. For example, depth measurement system 10 of spectral imaging system 80 may be mounted on a mount that is provided with sensors (e.g., tilt sensors, gyroscopes, encoders, compasses, or other sensors) for measuring an orientation of depth measurement system 10. Alternatively or in addition, depth measurement system 10 may be incorporated on a smartphone (e.g., handheld) or other device with capability of measuring an orientation or rotation when moved manually or automatically.

As depth measurement system 10 is rotated with rotation 86, different parts of object 82 may be illuminated with light of each wavelength. Utilizing the known spectral distribution of wavelength-encoded light pattern 40, as well as a position of each part of object 82, e.g., resulting from a previous depth measurement using depth measurement system 10, the wavelength of light that impinges on each region of object 82 may be known. A rotation 86 of depth measurement system 10 to a known orientation relative to object 82 may then successively illuminate each part of object 86 with light of each wavelength.

The spectral intensity of light in wavelength-encoded light pattern 40 may be known at the time of each image acquisition. For example, light that is returned to color camera 14 by reference surface 84 may be monitored (e.g., included in each image or monitored by a separate sensor). Reference surface 84 may be placed at a known location relative to depth measurement system 10 and may have known spectral characteristics (e.g., having a known spectral reflectance having a known angular dependence, e.g., a neutral white or gray surface). Alternatively or in addition, one or more sensors may be configured to directly monitor light that is emitted by emission unit 12. Thus, each successively acquired image may be normalized for variations in output of light source 30 or of emission unit 12.

For example, at one orientation of depth measurement system 10, region 82a of object 82 may be illuminated with light of one wavelength. After a rotation 86, region 82b may be illuminated with light of that wavelength, while region 82a is illuminated with light of a different wavelength. Measurement of the brightness (e.g., not necessarily color) of each part of an image of object 10 when reflecting wavelength-encoded light pattern 40 may enable measurement of a spectral (e.g., multispectral or hyperspectral) description of each region 82a or 82b of object 82. For example, the spectral description may include a specular or scattering spectral reflectivity of each region 82a or 82b of object 82. In calculating the spectral reflectivity, previously acquired depth measurements may be utilized to compensate for an effect of distance on the spectral intensity of light that is incident on, and that is returned by, a part of object 82.

When rotating depth measurement system 10 with rotation 86, known tracking or image registration techniques (e.g., based on correlations between successively acquired images, or otherwise) may be applied to enable identification of regions 82a and 82b in successively acquired images. Thus, the spectral reflectance or scattering properties of each region 82a or 82b of object 82 may be calculated.

In some cases, two or more emission units 12, e.g., each emitting a wavelength-encoded light pattern 40 in a different spectral range, may be used. In this manner, the spectral coverage of spectral imaging system 80 may be broadened.

In some cases, a hyperspectral imaging system may include a non-dispersed light source (e.g., white, or otherwise having a broad spectral range), where color camera 14 views the scene via a narrow bandpass filter.

In some cases, depth measurement system 10 may be incorporated into a portable platform, such as a smartphone.

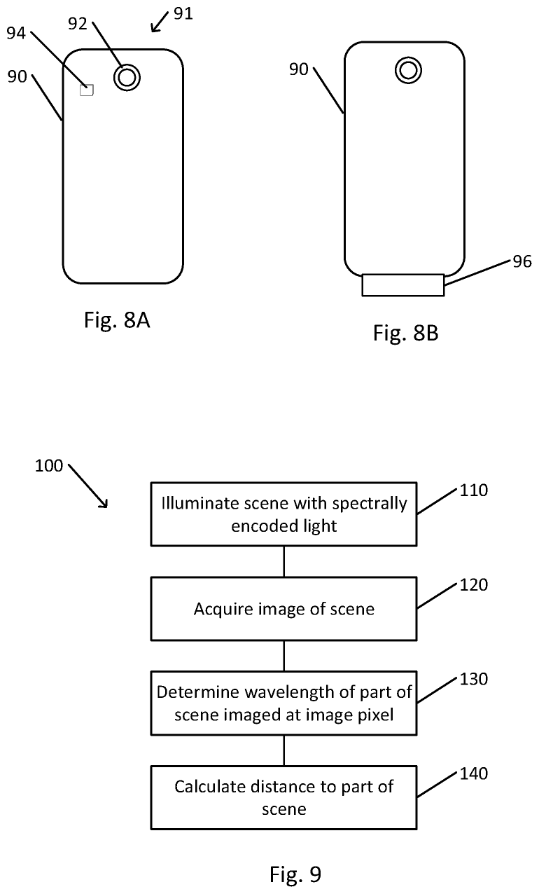

FIG. 8A schematically illustrates a smartphone that is provided with a depth measurement system as shown in FIG. 1.

In the example shown, smartphone depth measurement system 91 utilizes smartphone camera 92 of smartphone 90. Emission unit 94 has been incorporated into smartphone 90. In some cases, emission unit 94 may be added onto an existing smartphone 90. For example, emission unit 94 may be connected to a circuit board that is incorporated into smartphone 90, or may be connected to an appropriate connector of smartphone 90. Processor 17 and controller 15 may include or utilize processing capability that is provided by a processor and user interface (e.g., touchscreen) of smartphone 90, e.g., after downloading of an appropriate software application.

Alternatively, an entire depth measurement system 10 may be attached to smartphone 90, e.g., such that smartphone camera 90 is not used for depth measurement.

FIG. 8B schematically illustrates a smartphone that is provided with a plugin depth measurement system as shown in FIG. 1.

In the example shown, plugin smartphone depth measurement system 96 may be attached to smartphone 90, e.g., via a Universal Serial Bus (USB) connector. Processing capability and control may be provided by smartphone 90.

FIG. 9 is a flowchart depicting a method of operation of a depth measurement system, in accordance with an embodiment of the present invention.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Depth measurement method 100 may be executed by controller 15 and processor 17 of depth measurement system 10 (e.g., by a processor of a computer or smartphone that is in communication with depth measurement system 10). For example, depth measurement method 100 may be executed when a user has operated a user control or interface to indicate that a depth measurement is to be made of a scene toward which depth measurement system 10 is aimed.

Emission unit 12 may be operated to illuminate the scene with emitted light in the form of wavelength-encoded light pattern 40 (block 110). Emission unit may be configured such that wavelengths of wavelength-encoded light pattern 40 are in a spectral region in a transition spectral region between peak sensitivities of two types of pixels of camera sensor 16 of color camera 14.

Concurrently with emission of the light, color camera 14 may be operated to acquire one or more images of the scene (block 120). In some cases, acquisition of an image concurrently with operation of emission unit 12 may be preceded or followed by acquisition of an image of the scene when illuminated by ambient light.

The acquired image may then be analyzed to determine the wavelength of light that is received from (e.g., reflected or scattered, or otherwise returned by) each part of the scene and that is focused by camera optics 18 onto each image pixel 57 of camera sensor 16 of color camera 14 (block 130). For example, signals that are indicative of intensities measured by two or more types of pixels in each image pixel 57 may be analyzed (e.g., by solving a set of two or more simultaneous equations, by reference to a lookup table that tabulates previously calculated results of signals from sensors 54, or otherwise) to calculate a wavelength of light that was incident on an image pixel.

A calculated wavelength of light focused onto an image pixel 57 may be utilized to calculate a depth of (or distance to) a part of the scene that was imaged onto that image pixel 57 (block 140). The angle to the element may be calculated using knowledge of the geometry and optical properties of color camera 14. Conversion of wavelength into distance for each pixel may be based on a previously determined relationship based on results of previously performed calculations, simulations, or calibration measurements. These previously determined results may be utilized in the form of a functional relationship between wavelength and distance (and may be numerically derived by fitting calculated or measured data to a functional form, such as a polynomial or other form), or in the form of a lookup table.

In some cases, the depth data may be combined with image spatial data (e.g., in a plane that is approximately orthogonal to a line of sight to the scene) to create a three dimensional map of the scene.

In some cases, depth measurement system 10 may be operated while being rotated (e.g., in discrete steps, or at a rate that is sufficiently slow to obtain images with a predetermined level of resolution) so as to acquire a hyperspectral image of the scene. In this manner, a multidimensional description (e.g., three spatial dimensions plus a complete spectral description) of the object may be obtained. Results of depth measurements, e.g., by depth measurement system 10, or by another system, may be utilized in analyzing the acquired data to construct a spectral description (e.g., a multispectral or hyperspectral description) of the scene. For example, the spectral description may describe spectral reflectivity of each part of the scene. In some cases, the depth data may be utilized in determining which wavelength of the emitted light illuminated part of the scene, and in compensating for differences in the intensity of the illumination and of returned light that are affected by distance to that part of the scene.

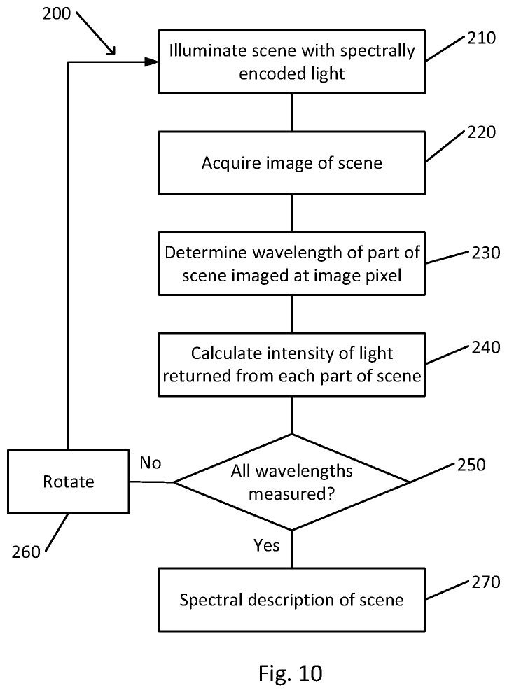

FIG. 10 is a flowchart depicting a method for acquiring a spectral description of a scene using the system shown in FIG. 1.

Spectral description method 200 may be executed by controller 15 and processor 17 of spectral imaging system 80, e.g., that includes the components of depth measurement system 10 with rotation capability (e.g., either mounted on a rotatable mount, or held in a manner that enables controlled rotation, e.g., pan, tilt, or both). For example, spectral description method 200 may be executed when a user has operated a user control or interface to indicate that a spectral measurement is to be made of a scene toward which spectral imaging system 80 is aimed.

Emission unit 12 may be operated to illuminate the scene with emitted light in the form of wavelength-encoded light pattern 40 (block 210).

Concurrently with emission of the light, color camera 14 may be operated to acquire one or more images of the scene (block 220). In some cases, acquisition of an image concurrently with operation of emission unit 12 may be preceded or followed by acquisition of an image of the scene when illuminated by ambient light.

The acquired image may then be analyzed to determine the wavelength of light that was incident on each part of the scene and that is focused by camera optics 18 onto each image pixel 57 of camera sensor 16 of a camera, e.g., a color camera 14, or a monochromatic camera (block 230). A part of the scene may refer to a distinct surface (e.g., a side of an object), or may refer to a region that is imaged onto a particular pixel or pixels of camera sensor 16. Knowledge of the dependence of wavelength on angle of emission of wavelength-encoded light pattern 40, together with knowledge of the distance to each part of the scene, may be combined (e.g., using geometrical or trigonometric calculations) to calculate the wavelength of light that was incident on each part of the scene. For example, previously acquired depth information may have been acquired by spectral imaging system 80 functioning as depth measurement system 10, or by a different depth measurement system 10 or otherwise (e.g., a rangefinder system). Alternatively or in addition, signals that are indicative of intensities measured by two or more types of pixels in each image pixel 57 may be analyzed (e.g., by solving a set of two or more simultaneous equations, by reference to a lookup table that tabulates previously calculated results of signals from sensors 54, or otherwise) to calculate a wavelength of light that was incident on each image pixel of a color camera 14.

The intensity of the light that is returned by each part of the scene may be measured by analysis of the pixel values (block 240). The measured intensity may be normalized by a measured or calculated intensity of the emitted light at each angle and wavelength. For example, the values may be normalized in accordance with a reference measurement by a sensor that is directly illuminated by wavelength-encoded light pattern 40. Alternatively or in addition, the normalization may be based on measurements of reflection from a reference surface of known spectral reflectance that is directly illuminated by wavelength-encoded light pattern 40. The intensity measurement may be further normalized by the known distance or each part of the scene. For example, the intensity of wavelength-encoded light pattern 40 that impinges on each part of the scene may depend on the distance of that part from emission unit 12. Similarly, the intensity of light that is returned by a part of the scene and is incident on the camera sensor may depend on the distance of the part of the scene from the camera. Further normalizations may account for an angle between a line of sight to the part of the scene and an optical axis of spectral imaging system 80.

The normalized intensities may then be indicative of spectral reflectance (e.g., specular or scattering) of the surface at that part of the scene.

The wavelengths for which intensities are calculated for one or more parts of the scene may be compared with a predetermined set of wavelengths for which measurements are to be made (block 250). For example, the set of wavelengths may include sampling the spectrum of wavelength-encoded light pattern 40 at predetermined wavelengths or wavelength intervals. In some cases, e.g., due to geometric limitations of spectral imaging system 80, the set of wavelengths for one part of the scene (e.g., near a center of the scene) may include more wavelengths than another part of the scene (e.g., at a periphery of the scene).

When there remain parts of the scene that have not been exposed to all of the predetermined wavelengths of wavelength-encoded light pattern 40, spectral imaging system 80 may be rotated to exposed each part of the scene to a different wavelength of wavelength-encoded light pattern 40 (block 260). For example, a mount with a motorized pan and tilt control may be operated to change a pan angle, a tilt angle, or both of spectral imaging system 80. Alternatively or in addition, a user may be instructed to manually rotate spectral imaging system 80. After the rotation, another measurement may be made (blocks 210-240).

After measurements have been made with all parts of the scene exposed to all wavelengths of the predetermined set of wavelengths (block 250), a spectral description of the scene may be complete (block 270). In some cases, e.g., depending on the number of wavelengths measured, or other criteria, the spectral description may be describable as a multispectral or hyperspectral description of the scene.

Different embodiments are disclosed herein. Features of certain embodiments may be combined with features of other embodiments; thus certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A depth measurement system comprising:
an emission unit that is configured to emit light in a continuous wavelength-encoded light pattern in which the emitted light varies with a direction of emission and in which the wavelength of the light that is emitted in each direction of emission is known; and
a camera that is located at a known position relative to the emission unit and that is configured to acquire an image of light that is returned by a scene that is illuminated by the wavelength-encoded light pattern, a sensor array of the camera onto which the scene is imaged configured to enable analysis of the image by a processor of the system to determine a wavelength of light that is returned to the camera by a part of the scene and to calculate a depth of the part of the scene based on the determined wavelength.

2. The system of claim 1, wherein the emission unit comprises a narrow bandpass filter that exhibits a blue shift effect.

3. The system of claim 2, wherein a central wavelength of a spectral band of light that the narrow bandpass filter is configured to transmit at a nominal angle of incidence is selected to be a wavelength at a long wavelength end of a transition spectral region within which a spectral sensitivity of one type of sensor of the sensor array monotonically increases with increasing wavelength, and a spectral sensitivity of another type of sensor of the sensor array monotonically decreases with increasing wavelength.

4. The system of claim 3, wherein the nominal angle of incidence is perpendicular to a surface of the narrow bandpass filter.

5. The system of claim 1, wherein the emission unit is at least partially enclosed in walls having reflecting interior surfaces.

6. The system of claim 1, wherein a light source of the emission unit comprises a light emitting diode.

7. The system of claim 1, wherein the emission unit is configured to enhance the brightness of light that is illuminating a part of the scene.

8. The system of claim 1, wherein the sensor array comprises a color filter array.

9. The system of claim 8, wherein the color filter array comprises a Bayer filter.

10. The system of claim 1, wherein the camera comprises a camera of a smartphone.

11. The system of claim 1, wherein the system is connectable to a connector of a computer or smartphone.

12. The system of claim 1, wherein the system is configured to operate at a plurality of known orientations relative to the scene.

13. The system of claim 12, wherein the images that are acquired by the camera during operation at the plurality of known orientations may be analyzed to give a spectral description of a surface of the scene.

14. The system of claim 13, further comprising a reference surface having known spectral characteristics.

15. A depth measurement method comprising:
operating an emission unit of a depth measurement system to emit light in a continuous wavelength-encoded light pattern such that a wavelength of the light that is emitted by the emission unit varies with a direction of emission such that the wavelength of the light emitted in each direction is known;
operating a camera of the depth measurement system to acquire a color image of a scene that is illuminated by the wavelength-encoded light pattern;
analyzing the color image by a processor to determine a wavelength of the light that was received from a part of the scene that is imaged onto an image pixel of a sensor array of the camera; and
calculating by the processor a depth of the part of the scene based on the determined wavelength.

16. The method of claim 15, wherein the emission unit comprises a narrow bandpass filter exhibiting a blue shift.

17. The method of claim 15, wherein calculating the depth comprises applying a predetermined relationship between the determined wavelength and the depth of the part of the scene.

18. The method of claim 15, wherein analyzing the color image to determine the wavelength comprises calculating the wavelength based on signals from at least two types of pixels of the image pixel.

19. A method for acquiring a spectral description of a scene, the method comprising:
operating an emission unit of the spectral imaging system to emit light in a continuous wavelength-encoded light pattern such that a wavelength of the light that is emitted by the emission unit varies with a direction of emission such that the wavelength of the light emitted in each direction is known;
operating a camera of the depth measurement system to acquire an image of a scene that is illuminated by the wavelength-encoded light pattern;
processing the acquired image to calculate a wavelength and an intensity of light that is returned by each part of the scene; and
when the acquired images of a part of the scene do not include measurements at all wavelengths of a predetermined set of wavelengths, rotating the spectral imaging system so that that part of the scene is illuminated by another wavelength of the wavelength-encoded light pattern.

20. The method of claim 19, wherein processing the acquired images comprises utilizing results of a depth measurement in calculating the wavelength or in calculating the intensity.
